(19) United States
(12) Patent Application Publication
(10) Pub. No.: US 2004/0154961 A1
(43) Pub. Date: Aug. 12, 2004

(54) Mehtod and device for separating fractions in a material flow

(76) Inventors: Morten Karlsen, Oslo (NO); Are Dyrøy, Porsgrunn (NO)

Correspondence Address: WENDEROTH, LIND & PONACK, L.L.P., 2033 K STREET N. W., SUITE 800, WASHINGTON, DC, 20006-1021, US

(21) Appl. No.: 10/471,176

(22) PCT Filed: Mar. 6, 2002
(86) PCT No.: PCT/NO02/00093

(30) Foreign Application Priority Data
Mar. 9, 2001 (NO) 2001 1231

(51) Int. Cl. B07C 5/00

(52) U.S. Cl. 209/44.2

(57) ABSTRACT

The present invention concerns a method and a device for separating and extracting fractions in a material flow of a material consisting of particles of different fractions. The device comprises a closed conduit (7) with an inlet end and an outlet end through which the material is transported. A separation chamber (17) is mounted between the inlet end and the outlet end. The separation chamber comprises at least one fluidisation element (13) at the base of the chamber and an extraction device (9) located in the upper part of the chamber. In use the present invention has proved to be particularly well suited to continuous separation of dust from a fluidisable mass where there is a need for high capacity.

The present invention concerns a method and a device for separating fractions such as fine material in a material flow. The present invention relates in particular to the treatment of fluidisable materials consisting of particles by continuous fine faction reduction of such materials.

One problem which may arise in connection with extensive transport of fluidisable materials is that the particles are crushed to finer fractions during transport/handling. If the material to be transported has too high a proportion of fine particles or dust, this can create serious operating problems both in the transport system itself and also in connection with downstream use of the material. Such problems may include segregation, the build-up of sediment or dust layers and metering and discharge problems. In particular in connection with the transport and feeding of alumina or fluoride in connection with an electrolysis system, such problems can produce very undesired operating problems.

U.S. Pat. No. 4,692,068 concerns an apparatus with which the quantity of a fluidisable material can be adjusted. The apparatus consists of a storage tank, a fluidisation element, a pipe for balancing the pressure/degasification and an outlet aperture for discharging fluidised material. According to the description, the quantity of fluidised alumina which flows out of the apparatus is controlled just by adjusting the pressure of the fluidisation gas supplied to the apparatus. The patent does not state whether this apparatus can be used as a separator for the removal of finer fractions from a material flow.

The present invention allows problems which arise as a consequence of too high a proportion of finer fractions in the material flow to be reduced considerably. With the present invention, the finer particles are extracted from the material flow so that the breadth of the size distribution is reduced, which reduces the potential for segregation. The fact that the finer fraction is removed also results in a reduction in the potential for the production of dust.

The present invention will be described in further detail in the following by means of examples and figures, where:

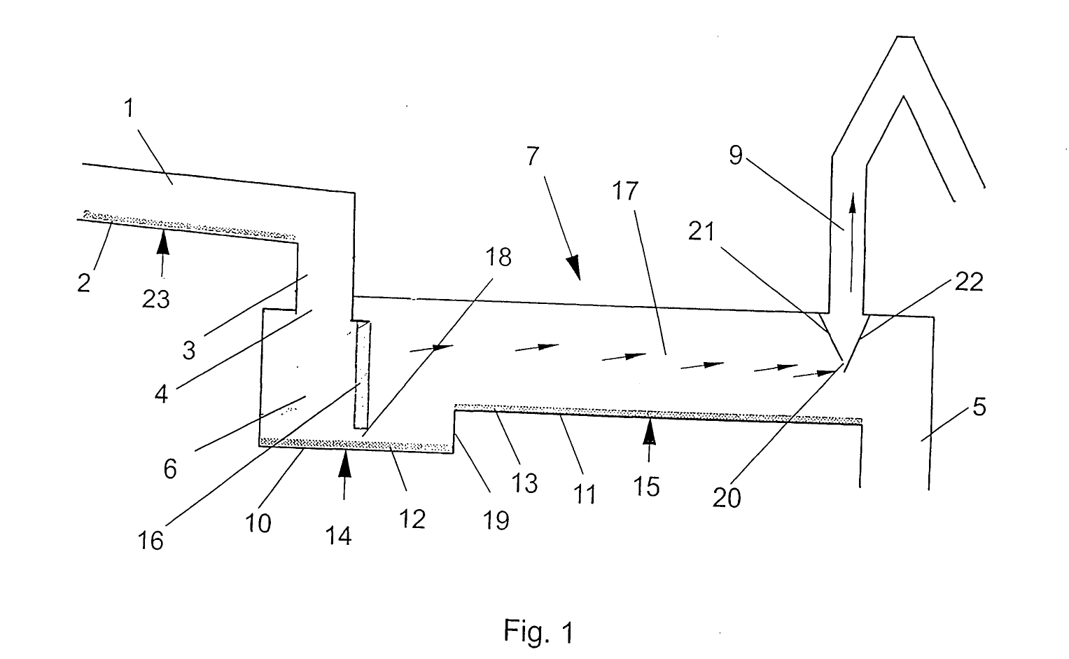

FIG. 1 shows a schematic diagram of a device in accordance with the present invention.

As FIG. 1 shows, the device comprises an inlet channel 1 for the supply of fluidisable material. A fluidisation element 2 connected to a pipe for pressurised gas 23 is mounted in the base of the channel. The inlet channel has a slight inclination and goes into a vertical, downward part 3, which comprises an outlet aperture 4. The outlet aperture may be narrower than the cross-section of the vertical, downward part if a constriction which partially covers the cross-section is inserted (not shown). The material which leaves the outlet aperture enters a distribution chamber 6 mounted at one end of a horizontal, closed conduit 7. At its other end, the conduit is equipped with a downward outlet 5 and between its ends the conduit is connected to an extraction device 9 from above. The extraction device has a gap-shaped aperture 20 which covers the width of the chamber and extracts in the direction of flow. The aperture can be created between two transverse, inclined plates 21, 22 which extend down into the separation chamber 17, with plate 22 extending slightly further down into the chamber than plate 21.

In the area between the distribution chamber 6 and the outlet 5, a separation chamber 17 is defined in the conduit. The conduit 7 in accordance with the example has a base with different levels, where base 10, with a lower level, is mounted in connection with the distribution chamber 6, and base 11, with a higher level, is located downstream from the latter. Fluidisation elements 12, 13, connected to the store of pressurised gas via pipes 14, 15 respectively, are mounted in the base of the conduit. It is expedient for the conduit 7 to be very wide along its entire length in relation to the width of the inlet channel 1. For example, the width ratio between the conduit 7 and the inlet channel 1 may be in the order of 100:1 to ensure a large active (fluidised) area in the separation chamber.

Between the distribution chamber 6 and the separation chamber 17 there is a vertical partition 16 which creates a gap 18 between itself and the base 10. The partition will contribute to the creation of a hydrostatically driven material flow from the distribution chamber 6, through the gap 18, over the threshold 19 between base 10 and base 11 and into the separation chamber 17 when the fluidisation elements 12, 13 are activated. The hydrostatic pressure will primarily depend on the filling height above the base in the distribution chamber 6. The parameters which concern the material flow are important to the ability to maintain a stable material feed to the separation chamber and, consequently, optimal conditions there. This aspect is particularly important when the variations in the quantity of material transported via the device are large, for instance from down towards 0 tonnes per hour up to several tonnes per hour. The distribution chamber with partition 16 and threshold 19 will also contribute to ensuring an even distribution of material towards the separation chamber 17 in terms of both the distribution of material across the conduit and the thickness of the material which flows through the separator chamber being kept constant through the separation chamber. This can be achieved because the material which is in a fluidised state will be distributed approximately like a liquid, for example water, and the distribution out through the separation chamber is constant if the device is mounted in a position so that the base is mainly horizontal. The conduit may be mounted so that its base is slightly inclined downwards in the direction of flow in order to ensure that the transport towards the outlet is supported.

In the separation chamber, small particles with a lower sedimentation speed (i.e. a larger coefficient of drag) than coarse particles can be separated out if the mass is overfluidised. Depending on the specifications for the individual design, particles with a size of up to 50 micrometres, for example, can be overfluidised so that they are lifted up through the fluidised mass flow and extracted by the extraction device 9. The decisive factors for adjusting the separator's ability to extract the correct smallest particle sizes will include the thickness of the fluidised material layer in the separation chamber 17, the dwell time and the fluidisation speed initiated by the fluidisation element 13 in combination with the extraction device. The fine fractions which are extracted are transported on to gas/particle separation (for example, a filter), where the particles can be conveyed to a store for possible further use. That part of the material which passes through the separation chamber without being extracted runs into the outlet 5, which may consist of a funnel-shaped outlet or a tank (not shown) for collection and reduction of the width of the equipment for further transport.

Typical values for the fluidisation gas in accordance with the solution described in the above example will be a fluidisation speed of approximately 2 cm/second in the distribution chamber 6 and a fluidisation speed from 10 cm/second and upwards in the separation chamber 17. The extraction device may expediently be operated with a relatively marginal negative pressure.

The device, which is designed to handle fluidised material, can treat large quantities of material such as alumina. The device can easily be constructed to handle from 0 tonnes per hour up to several tonnes per hour. This means that the device can be used as a control unit for variations and peaks in the quantity of fine fraction to be separated out. Such situations may occur, for example, in connection with deliveries to factory units and the main store at an aluminum factory or when loading ships from alumina production plants.

A test was performed with a device in accordance with the present invention with an active zone (zone with high fluidisation speed) of 0.5 m² and it was found to be functional up to 6 tonnes per hour. If required, several devices can be connected in series to achieve the desired separation/extraction of fine fractions.

Alternatively, the active zone in the separation chamber can be increased in size by extending its width or length. The effect of the device is determined by the thickness of the material layer in the active zone, the material's dwell time in the zone, the fluidisation speed and the extraction rate. Tests performed at different fluidisation speeds show that the fine fractions are expelled approximately proportionally to the fluidisation speed. In use the present invention has proved to be particularly well suited to continuous separation of dust from a fluidisable mass where there is a need for high capacity.

1. A method for separating and extracting fractions in a material flow of a material consisting of particles of different fractions, characterised in that the material consists of a fluidisable material which is put in a fluidised state by means of at least one fluidisation element (13) located beneath the material and the finer fractions of the material are overfluidised and expelled by means of an extraction device (9) located above the material.

2. A method in accordance with claim 1, characterised in that the material is conveyed through a closed conduit (7) comprising a separation chamber (17) and an inlet which consists of a distribution chamber (6) for hydrostatic feeding and even distribution of the material to the separation chamber.

3. A method in accordance with claim 1, characterised in that the material consists of alumina and/or other equivalent fluidisable materials.

4. A method in accordance with claim 1, characterised in that the material consists of fluoride.

5. A method in accordance with claim 1, characterised in that the finer fractions which are expelled consist of particles of up to 50 micrometres.

6. A device for separating and extracting fractions in a material flow of a material consisting of particles of different fractions, characterised in that it comprises a closed conduit (7) with an inlet end and an outlet end through which the material is transported, and where a separation chamber (17) is mounted between the inlet end and the outlet end, the separation chamber comprises at least one fluidisation element (13) at the base of the chamber and an extraction device (9) located in the upper part of the chamber.

7. A device in accordance with claim 6, characterised in that the inlet end of the conduit (7) comprises a distribution chamber (6) which ensures even distribution of the material towards the separation chamber (17).

8. A device in accordance with claim 7, characterised in that the distribution chamber (6) comprises a vertical partition (16) which ends above the base (10) of the distribution chamber so that a gap (18) is formed through which the material is conveyed into the separator chamber (17).

9. A device in accordance with claim 7, characterised in that the base (10) of the distribution chamber (6) is located lower than the base (11) of the separation chamber (17) so that a threshold (19) is formed between them.

10. A device in accordance with claim 6, characterised in that the extraction device (9) is designed with a gap-shaped aperture (20) which extends downwards and into the separation chamber (17).
